(19) United States
(12) Patent Application Publication
(10) Pub. No.: US 2013/0284865 A1
(43) Pub. Date: Oct. 31, 2013

(54) Support Structure and Method of Attachment

(71) Applicant: Stephen Royce TEWKESBURY, SHANGHAI (CN)

(72) Inventor: Stephen Royce TEWKESBURY, SHANGHAI (CN)

(21) Appl. No.: 13/457,467

(22) Filed: Apr. 26, 2012

(51) Int. Cl. A47B 95/00; B23P 11/00

(52) U.S. Cl. 248/176.1; 29/700

(57) ABSTRACT

This invention relates to a uniquely shaped upright support post to which various components and attachments may be affixed in a multiple of directions. The rolled steel, open T shaped upright support post creates 7 vertical column faces, accommodating 8 fixing points and utilises 4 different slot shapes. This patent application is not applying for the various possible attachments, only the post design, multiple points and method of attachment. The flexibility of the post design allows users to interact in different ways with various materials to create a framework to form cabinets, shelf units, racking, work benches, work tables in either freestanding, fixed or mobile formats.

### BACKGROUND OF THE INVENTION

The core of this invention comprises uniquely shaped upright posts and points of fixing that result in a new and improved method with flexibility to fix various attachments to form cabinets, racking, shelving, work benches, storage or display units, of various heights and widths.

The T shaped upright post and 7 vertical column faces that accommodate 8 fixing points and 4 different slot shapes comprises the primary object of the invention. In combination with angle top and bottom joiners of two uprights a solid frame can be formed and joined horizontally or vertically. The rigid nature of the upright posts allows a user to fix attachments widely or narrowly spaced and still retain structural integrity.

Various designs have been proposed in recent years generally for specific single use purposes, some examples are Storeroom Shelving U.S. Pat. No 2,991,888, Cabinet Structure and Method of Construction, U.S. Pat. No. 4,045,104, Support Structure and Method of Assembly, U.S. Pat. No. 2002/0171338 and Storage Rack with improved Beam to Column Connector U.S. Pat. No. 5,131,781.

Drawbacks of most if not all designs are upright support posts that are either a right angle shape, square or round and a subsequent restriction to a single method of fixing various component attachments and ultimately limits the functionality of the end product to either a cabinet e.g. U.S. Pat. No. 4,045,104 or storage rack e.g. U.S. Pat. No. 5,131,781 and U.S. Pat. No. 2,991,888. Other restrictions are placement of shelves in terms of height or spaces between shelves that impact structural integrity e.g. U.S. Pat. No. 2002/0171338 (a two part upright post with a joiner that effectively blocks connector slots).

This invention challenges these norms by utilising a 7 sided upright post and carefully positioning 4 different shaped slots that together allow multiple points of fixing for different attachments. The post is not limited to one or the other function. These may include but are not limited to attaching beams, shelves, panels, brackets, wheels, hooks and any other accessories that utilise the appropriate fixing points. Accessories could include but are not restricted to containers, pockets, tool holders, fishing gear, pipe holders the list is quite endless but dependent on the method and position of fixing.

A key process in manufacturing required compensating for the various steel stretch distortions caused by the 4 different shaped slots and their respective proximity to edges as the posts are roll formed. The engineering process is a matter of confidentiality.

### BRIEF SUMMARY OF THE INVENTION

Having the perception of the incompetence of other existing systems in achieving multi-functional effects in mind, we have made the following technical proposals: One upright has 7 fixing column faces and 8 fixing points, and 4 different styles of fixing slots. The primary innovation central to the system flexibility and functionality is a T shaped support post that facilitates the fitment of multiple attachments and is designed to allow left and right extension to an indefinite length.

The positioning of two upright support posts opposite each other with the lower T point facing inward and welding two outward L angle iron joiners 600 mm long and spaced 3 mm apart forms a rectangular frame. This frame can be stacked vertically and/or connected to another frame by attaching a beam horizontally left and/or right.

The design of the 8 fixing points allows a multitude of attachments with various methods of attachment. Methods of attachment include but are not limited to hooks and locking pins, steel rivet rings to fit the 4 slots as per:

1. A circular hole for fixing with screws, bolts or rivets.

2. Rhombic slots to accept a flanged connector and locked in place with a locking pin.

3. Tear drop shaped slots to accept a circular steel rivet.

4. A long square slot.

The positioning and welding of angle iron top and bottom braces to two upright posts, forms a rectangular frame ensuring rigidity and allows stacking vertically. The angle braces are spaced apart to allow side panels to be fixed within or external to the frame. Such panels can be formed of various materials, sheet metal, perspex, timber materials etc as per a users preference or material availability and fixed firmly by method 1 above. Such panels may be sourced separately from home improvement stores.

Primary specific elements of this utility innovation.

1. Support posts in a formed open T configuration resulting in 7 different vertical sides and 8 points of fixing.

2. The T shaped post enables attachments in multiple aspects at the same time.

3. Utilising 4 different style fixing slots that are positioned complementary to each other so that attachments can be fixed at any and all points and still be aligned to accommodate doors, drawers, shelves and beams.

The kit for forming a support structure consists of angle iron cross beams welded top and bottom to the claimed upright posts standing vertically opposite to each other to enable three specific configuration options.

1. The frames can be joined and bolted vertically to a height of 2.7 metres.

2. The split angle iron beams allow side panels to be fitted vertically within the frame.

3. The same method of joining frames vertically is used to attach wheel sets to the base.

### BRIEF DESCRIPTION OF THE DRAWINGS

The specific elements of this invention will become more easily apparent from a consideration of the following detailed description and accompanying drawings.

FIG. 1. Is a flat perspective of the T shaped upright post prior to cold rolling manufacturing and clearly shows the 8 points of fixing and relative orientation.

In the drawing the dash line is the folding line, from left to right on the first face is the first fixing point with the \textcircled{1} Circular hole, second face is the second fixing point with \textcircled{2} Rhombic slot, on the third face is the third fixing point with the \textcircled{3} Tear drop slot, on the 4^{th} face is the fifth and six fixing point with \textcircled{4} Long square slot, on the 5^{th} face is the seven fixing point with \textcircled{3} Tear drop slot, on the 6^{th} face is the seven fixing point with \textcircled{2} Rhombic slot, on the 7^{th} face is the eight fixing point with \textcircled{1} Circular hole.

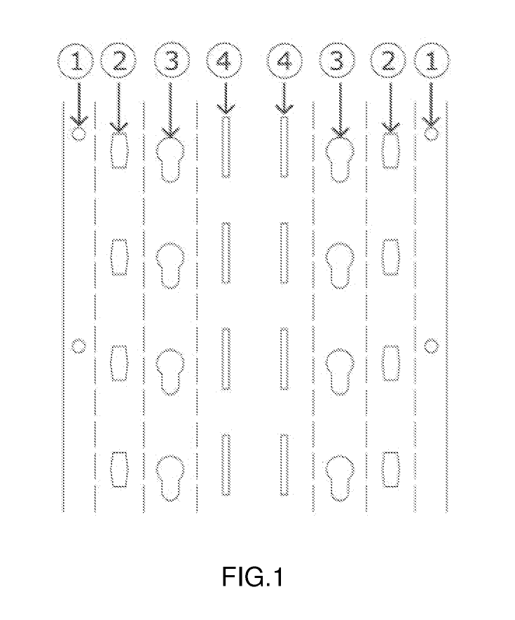

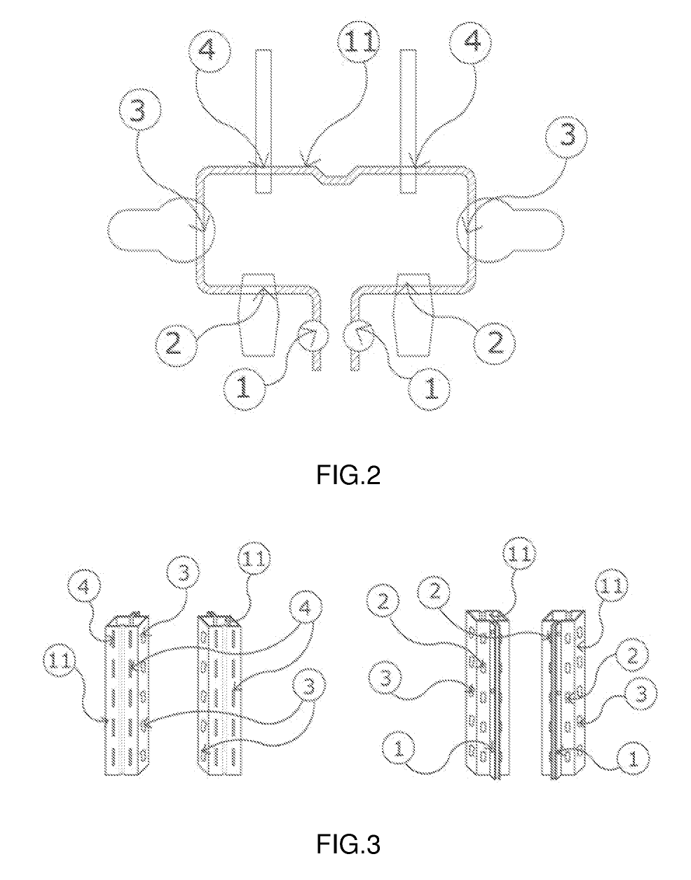

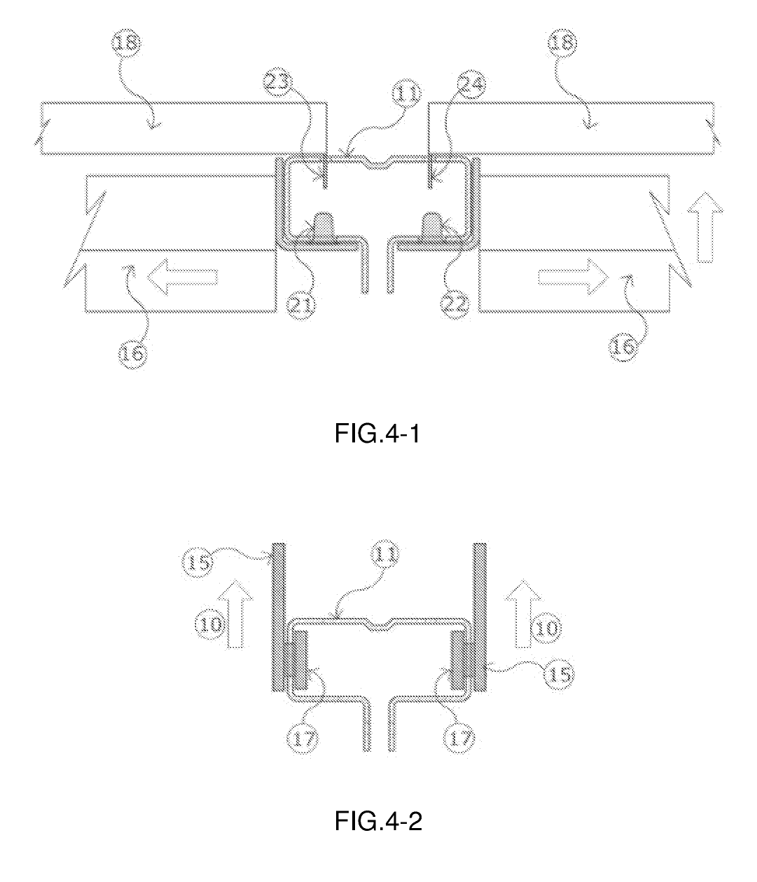

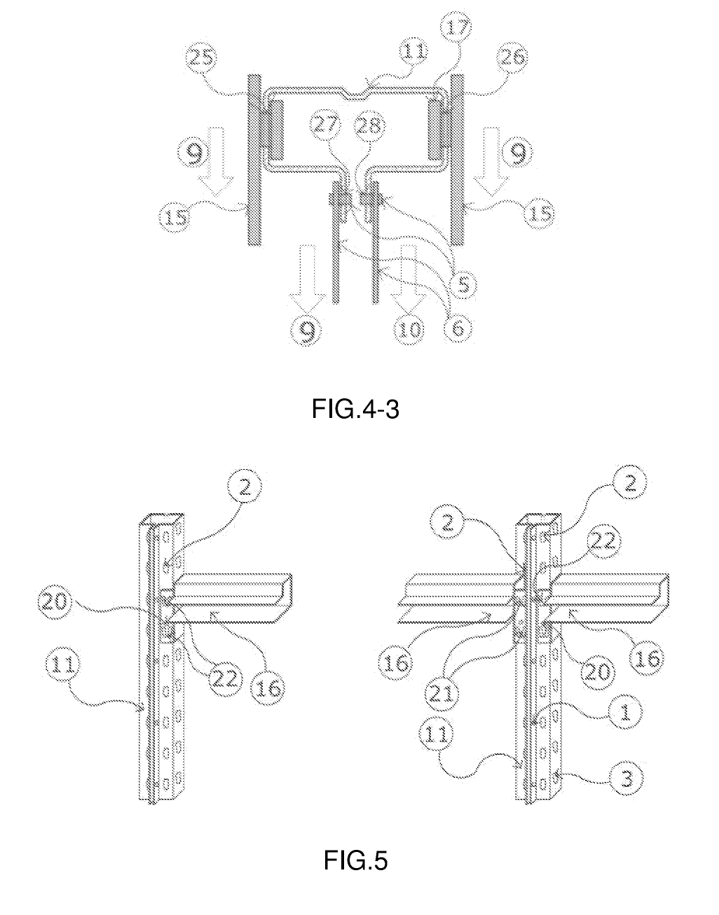

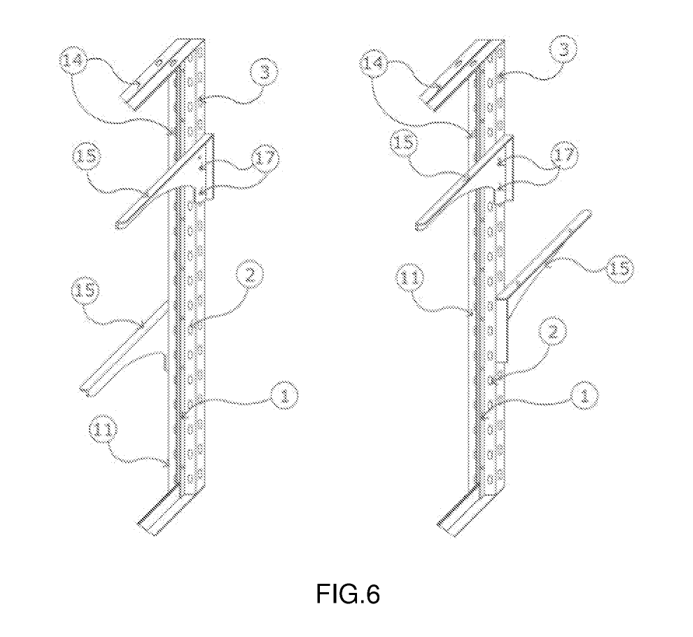

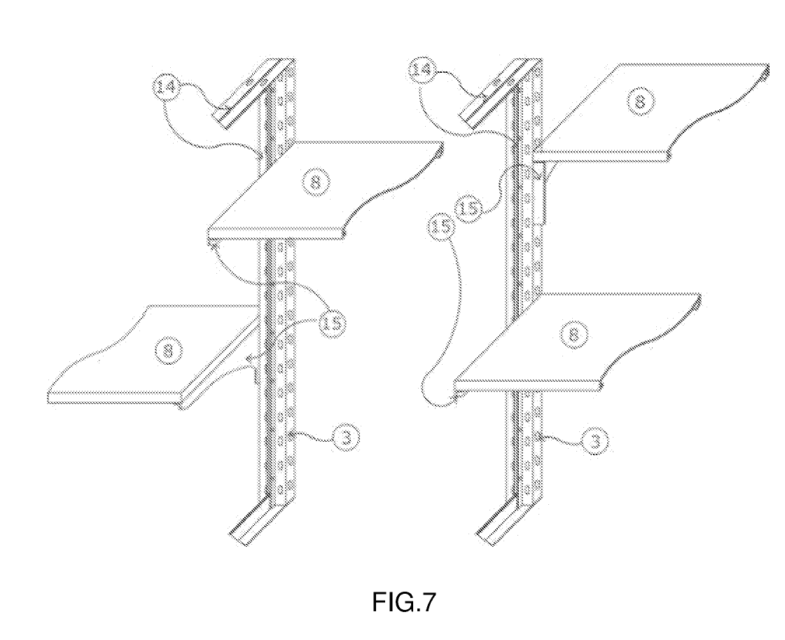

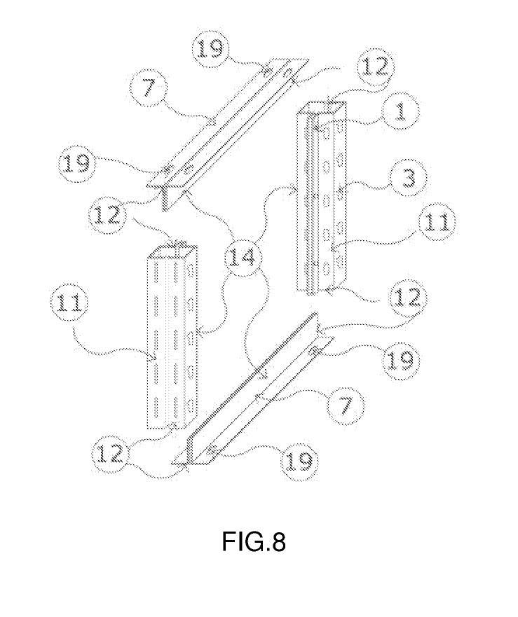

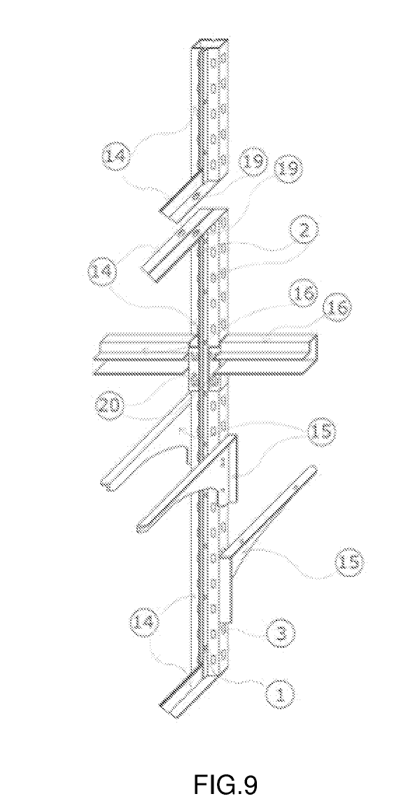

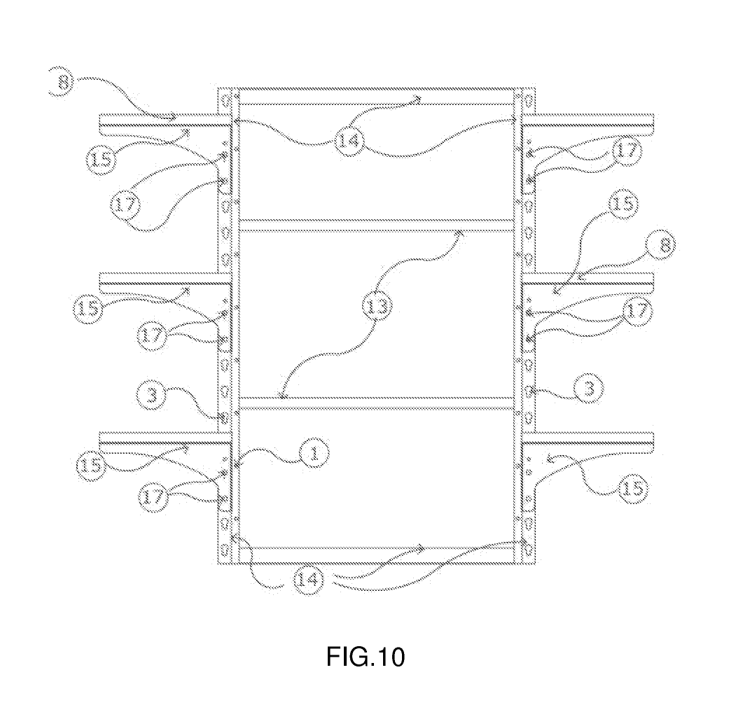

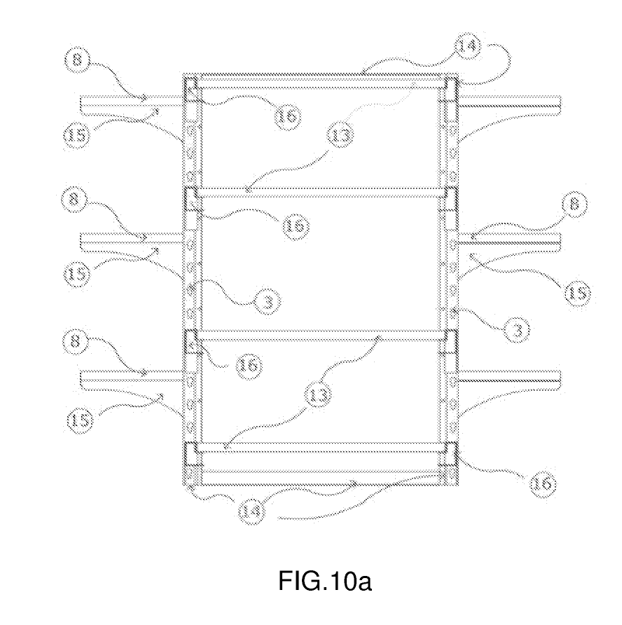

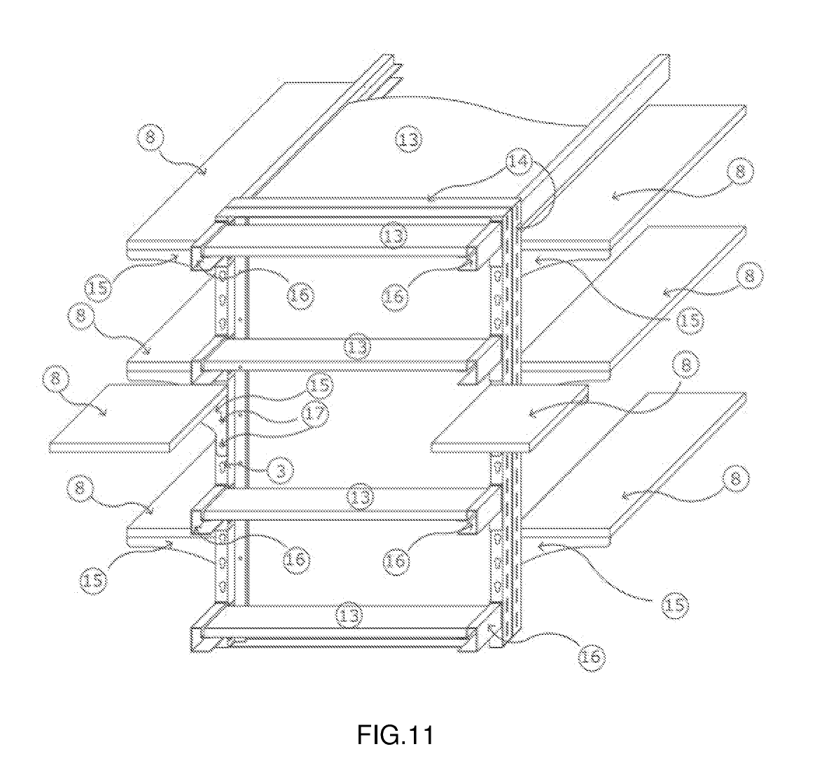

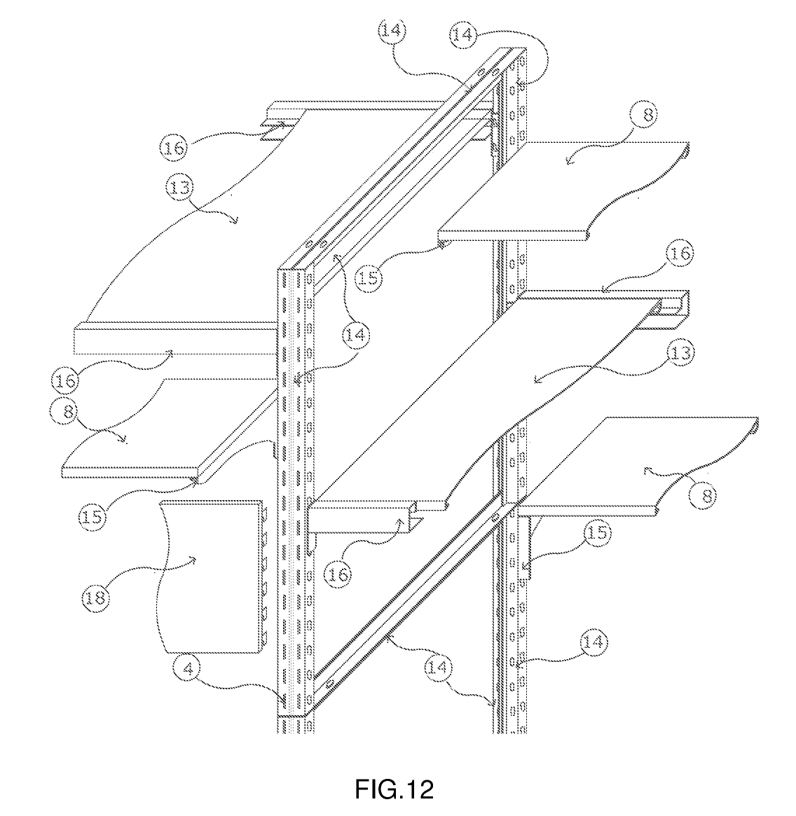

FIG. 2 is a top down view of the cold rolled steel T shape upright post describing the location of the slots described above. On the FIG. 2 the \textcircled{1}\textcircled{2}\textcircled{3}\textcircled{4} indicate the type and placement of holes as described in FIG. 1 prior to the manufacturing rolling process.

FIG. 3 Perspective of the T shaped upright post showing relative fixing positions. The perspective shows from a different angle that upright post \textcircled{11} have 4 types of slots \textcircled{1},\textcircled{2},\textcircled{3},\textcircled{4} on 7 faces created 8 fixing point.

FIG. 4-1 to FIG. 4-3 shows the directions that attachments may be fixed for each post. These drawings show 8 different points of fixing. Note points 25 and 26 can be forward and rearward facing. FIG. 11 also demonstrates this feature from a perspective view.

FIG. 4-1 Shows on the fix point 21 and 22 are the \textcircled{2} Rhombic slots, can fix the beam \textcircled{16} n both left and right side at the same time to the same upright post \textcircled{11} in 90°, FIG. 5 will show in a perspective view.

Fix points 23 and 24 are the Long square slot \textcircled{4}, can fix the back panel \textcircled{18} the left and right on to the upright post \textcircled{11} in 90°. Shown in FIG. 12 in a perspective view.

FIG. 4-2, and FIG. 4-3 Shows that the fixing point 25 and 26 are the Tear drop slots \textcircled{3}, they can fixed the bracket \textcircled{15} on left and right side by rivet \textcircled{17} in 90°, also can be forward \textcircled{9} and backward \textcircled{10}. Shows in FIG. 6 in a perspective view.

Fixing point 27 and 28, are the Circular holes \textcircled{1}, they can adds on panels and accessories \textcircled{6} with screws.

FIG. 5A perspective of the T shaped upright post connected with beams.

The beam \textcircled{16} is fixed to the upright post \textcircled{11} at the Rhombic slot fixing point 22, into the Rhombic slot \textcircled{2} at the right side of the upright post like the left picture shows.

And the beam \textcircled{16} also can be fixed to the upright post \textcircled{11} at the Rhombic slot fixing point \textcircled{21}, at the same time like the picture shows below at right. The objective is to insert a locking pin \textcircled{20} and prevent beam dislodgement.

FIG. 6 presents how the brackets \textcircled{15} connected to the frame \textcircled{14}. The brackets \textcircled{15} connect to the tear drop slots \textcircled{3} with the rivet \textcircled{17} and be locked by locking pin \textcircled{20}, it could be fixed left or right side on the post like it shows on the picture below at left, and also could be fixed forward and backward like shows on the picture below at right.

FIG. 7 followed the FIG. 6, when the bracket \textcircled{15} could be fixed left or right side on the post, the side shelf \textcircled{8} also could be fixed left or right side on the post like it shows on the picture below on the left, and side shelf \textcircled{8} also could be fixed forward and backward like picture shows below on the right.

FIG. 8 View of two vertical upright posts joined to form a rectangular frame.

Positioning two upright support posts opposite each other with the lower T point facing inward and welding two outward facing L angle iron joiners 600 mm long and spaced 3 mm apart at the bottom and a second set in reverse at the top forms a solid rectangular frame.

The frame can be used in many configurations to accommodate various attachments manufactured by the applicant or attachments as decided by the user.

Two pieces of \textcircled{11} right post one is the front post, one is the back post, they are face to each other, and welded at \textcircled{12} to 4 pieces of \textcircled{7} L shape angle support. These build up \textcircled{14} the frame and the frame is the key piece in the whole system.

The flexibility of the post design allows users to interact in different ways with various materials. FIG. 5 above shows a welded cross section to from a frame. Similarly a user may choose to use different materials and utilize the tear drop slot or the round whole slot to fix cross members and form a frame with different materials.

FIG. 9 A summary drawing demonstrating the 7 sided, 8 points of fixing and vertical stacking configuration.

Beam \textcircled{16} connect to the frame \textcircled{14} by \textcircled{2} Rhombic holes, bracket \textcircled{15} connect to the frame \textcircled{14} by \textcircled{3} tear drop slots.

To build a shelving system higher, the frame \textcircled{14} is joined to the top of a lower frame \textcircled{14} using holes \textcircled{19} to insert bolt to firmly fix the top frame to bottom frame. Three frames can be joined in this manner to form a frame vertically to a height of 2.7 meters.

FIG. 10 shows the brackets \textcircled{15} are fixed to the frame \textcircled{14} by rivet \textcircled{17}, and the side shelf \textcircled{8} is fixed on to the brackets \textcircled{15}.

FIG. 10a Incorporates beam fixings that provide support for internal shelves accessible from each end.

From the FIG. 6a shows the beam \textcircled{16} are connect on to the frame \textcircled{14} at both left and right side, shelf \textcircled{13} is placed in between the two beams.

FIG. 11. Flexible options of fixing internal, external rear or forward facing brackets are demonstrated by this end view. FIG. 11 presents a perspective view of the T shaped post and 7 fixing column faces and 8 fixing points, and 4 different styles of fixing slots in use. Depending on the depth and length of shelves and beams a 4 sided shelving cube is possible, alternatively not deploying the outward facing brackets, a standard beam and shelf rack unit can be configured. Only with the T shaped post and slot options is such flexibility possible.

Such as in the FIG. 11 The beam \textcircled{16} can connected on left and right and also can connected forward and backward, this give the option that the shelf \textcircled{13} can place next to each other as many as you want.

In the same way the brackets \textcircled{15} can connect on the frame \textcircled{14}, so the side shelf \textcircled{8} an be placed next to each other at both left and right side as many as you like.

FIG. 12 presents a cut away perspective of FIG. 6 to show how beams are attached left and right of the support post and internally facing brackets also at the same time to offer various depth shelf options, and shows how the back panel connected to the frame.

The back panel \textcircled{18} connect to the frame \textcircled{14} in to the long square slots \textcircled{4}, each frame can 3 pieces back panel on both left and right side. This will create a back for the shelf.

\textcircled{1} Circular hole

\textcircled{2} Rhombic slot

\textcircled{3} Tear drop slot

\textcircled{4} Long square slot

\textcircled{5} Nut and threaded bolt

\textcircled{6} Side cabinet panels or accessories

\textcircled{7} L shaped angle support

\textcircled{8} Shelf on bracket

\textcircled{9} Forward

\textcircled{10} Backward

\textcircled{11} Upright post

\textcircled{12} Welded together

\textcircled{13} Shelf on beam

\textcircled{14} Frame

\textcircled{15} Bracket

\textcircled{16} Beam

\textcircled{17} Rivet

\textcircled{18} Back panel

\textcircled{19} Hole for bolt top frame to bottom frame, and also for bolt the wheels on to the frame.

\textcircled{20} Locking pin

\textcircled{21} Rhombic slot fixing point A

\textcircled{22} Rhombic slot fixing point B

\textcircled{23} Long square slot fixing point A

\textcircled{24} Long square slot fixing point B

\textcircled{25} Tear drop slot fixing point A

\textcircled{26} Tear drop slot fixing point B

\textcircled{27} Circular hole fixing point A

\textcircled{28} Circular hole fixing point B

### DETAILED DESCRIPTION OF THE INVENTION

The present invention will now be described by referring to the accompanying drawings that illustrate the preferred embodiments of the invention, from which its objects and features will be evident. The foregoing descriptions of the embodiments and their accompanying drawings of the invention are intended to illustrate and not limit this invention. Various changes and modifications may be made to the embodiments without departing from the spirit of the invention. Therefore the scope of the invention is to be limited only by the appended claims.

References are made to attachments, beams, brackets, panels, doors, drawers etc. these references are simply to explain and help visualise the unique advantages of the 7 sided upright posts and the 8 points of fixing in 4 different methods. For example where a reference is made to a back panel, this could be substituted for a pool cue holder attachment, or fishing rod holder. Likewise a bracket attached to the tear drop slot could be extended toward the front of the unit or reversed to protrude from the rear of the post and create double sided utilization.

Referring to FIG. 1, none of the 8 stamped slots are centre aligned. The purpose of the offset positioning allows brackets and/or beams attached to the respective rhombic and tear drop slots to provide clear unrestricted access. The offset spacing allows for a beam to be exactly placed at the base and a top beam placed exactly at the top with a central beam equidistant in the center or not all whilst retaining structural integrity. The placement of the slots is critical to enable the insertion of shelves, doors and drawers within a tolerance of 2 mm in a vertical orientation. Each slot requires a specific dimension ‘male’ hook or protrusion to ensure a tight fit. In the case of the Rhombus slot an angled locking pin is required to avoid accidental dislodgement. The Tear Drop slot does not require a locking pin due to the tight lower point of the tear drop forming tightly around a rivet shaft.

FIG. 2 shows the location of the 8 slots around the outside perimeter of the support post. The location of the Rhombus slot \textcircled{2} lows a beam attachment to the right and left and therefore an infinite extension in linear terms if uprights are placed as if they were posts in a fence line. Likewise the long square slot \textcircled{4} allows panels or hanging brackets across the rear to link right and left and therefore an infinite extension in linear terms. There are various upright posts in the market place all typically restricted to fixing to no more than three faces and generally limited to a one or two hole shapes. The placement of the 8 slots required resolving steel stretching and distortion in the manufacturing process of the hole punched steel to form a straight edged, 7 sided post with 8 points of fixing and 4 different attachment slot styles being:

1. Circular hole, 2.Rhombic slot, 3.Tear drop slot, 4.Long square slot

The four uprights presented in FIG. 3 show the four different shaped slots in perspective when the upright is formed from the flat stamped material in FIG. 1.

The multi directional flexibility of these slots is indicated in FIG. 4. This visually demonstrates the various directions that attachments may be fixed for each post using the 8 different points of fixing. Note the fixing points numbered 25 and 26 can be forward and rearward facing. FIG. 11 also demonstrates this feature from a perspective view. FIG. 4-1 shows the fixing points 21 and 22 are \textcircled{2} Rhombic slots to fix the beam \textcircled{16} on both left and right side at the same time to the same upright post \textcircled{11} in 90°, FIG. 5 will show in a perspective view.

Fix points 23 and 24 are the Long square slot \textcircled{4}, can fix the back panel \textcircled{18} to the left and right on to the upright post \textcircled{11} in 90°. Shown in FIG. 12 in a perspective view.

FIG. 4-2, and FIG. 4-3 Shows that the fixing point 25 and 26 are the Tear drop slots \textcircled{3}, they can accept the fixing of the bracket \textcircled{15} on left and right side by means of rivet \textcircled{17} at 90°, also can be forward \textcircled{9} and backward \textcircled{10} facing. Shows in FIG. 6 in a perspective view.

Fixing point 27and 28, are the Circular holes \textcircled{1}, they can accept the attachment of panels and accessories \textcircled{6} with screws or threaded bolts and nut \textcircled{5} assemblies.

FIG. 5 Shows how the T shaped upright post connect with beams either right or left or both at the same time at equal or different levels. This feature allows an infinite length of joined frames or uprights to suit a user's needs.

FIG. 6 presents a simplified view of left and right and front or rear facing brackets using the tear drop slots at the same time. FIG. 6 Presents how the brackets \textcircled{15} connected to the frame \textcircled{14}. The brackets \textcircled{15} connect to the tear drop slots \textcircled{3} with the rivet \textcircled{17}, it could be fixed left or right side on the post and either be protruding forward or backward. Effectively allowing bracket supported shelves, baskets or other attachments in a continuous longitude and both sides of a single upright post.

FIG. 7 shows the same configuration with a cut away drawing if shelves are fitted to the brackets. The range of fitment in terms of type and direction are quite unique to this upright post invention.

FIG. 8 introduces a welded top and bottom angle iron joining element to demonstrate how a welded rectangular frame can be formed. Alternatively a user may choose to create a frame by attaching timber or steel braces attached to the circular holes shown. Another option is to attach brackets utilizing the tear drop holes. The submitted invention of the upright post design facilitates the forming of a support frame and various methods of fixing left, right, inward and outward facing, with various materials as a user may determine. The bottom angle iron joiners perform a few functions. A/ they provides a rigid base and top to the frame, B/ the base angle iron allows load spreading so downward weight is dissipated at the point of floor contact, C/ the use of angle iron provides vertical strength and rigidity, D/ it allows the fitting of wheels for mobility, E/ the 3 mm space between the two angle iron joiners and aligned within the T upright post allows side panels to slide into the frame and be fixed with screws, bolts or pop rivets.

The upper level angle iron joiner performs similarly, but in place of attaching wheels, the same connector points allow another frame to be placed vertically and bolted together forming a rigid load spreading tall vertical frame.

FIG. 9 provides a comprehensive view of various left, right, forward and rearward facing attachments to the posts and a cut away drawing a second upright placed above the lower upright in a vertically stacked orientation. To build a shelving system higher, the frame \textcircled{14} is joined to the top of a lower frame \textcircled{14} using holes \textcircled{19} to insert bolt to firmly fix the top frame to bottom frame. Three frames can be joined in this manner to form vertical structure to a height of 2.7 meters.

FIG. 10 is referenced to demonstrate how flexible the T shaped post and slot options are and shows an end view with outward facing brackets and internal beams placed at right angles to the brackets.

Another view of this is shown as FIG. 11 presents a perspective view of the T shaped post and 7 fixing column faces and 8 fixing points, and 4 different styles of fixing slots in use. Depending on the depth and length of shelves and beams a 4 sided shelving cube is possible, alternatively not deploying the outward facing brackets, a standard beam and shelf rack unit can be configured. Only with the T shaped post and slot options is such flexibility possible.

FIG. 12 describes how the many different attachment methods and directions come together in a single cut away perspective. It shows the seven sided upright post from a front perspective to demonstrate left and right beams fitted and at the same time internal brackets and shelves are fitted whilst a back panel is attached to the square slotted holes. A user is not limited to any or all of the various attaching methods. The invention described provides the means for multiple uses, multiple attachments in multiple directions at one or the same time using any or all of the seven fixing faces, four method of fixing or eight fixing points.

What is claimed is:

1. A steel roll formed post characterized by seven sides in a T shaped formation comprising eight separate points of fixing including four different style fixing slots or holes; the post as defined in accordance with this claim allows four way fixing—left, right, front facing and rear facing at one and the same time.

2. A kit for forming a support structure comprising two claimed upright posts standing vertically opposite to each other with angle iron cross beams welded to the top and bottom.

3. The kit for forming a support structure of claim 2 wherein the frames can be joined and bolted vertically to a height of 2.7 meters.

4. The kit for forming a support structure of claim 2 wherein side panels can be fitted vertically within the frame.

5. The kit for forming a support structure of claim 2 wherein wheel sets can be fitted used to the base of the support structure.
